(19) United States
(12) Patent Application Publication
(10) Pub. No.: US 2009/0291348 A1
(43) Pub. Date: Nov. 26, 2009

(54) ELECTROLYTE MEMBRANE FOR FUEL CELL AND METHOD OF MANUFACTURING THE SAME, MEMBRANE ELECTRODE ASSEMBLY AND FUEL CELL

(76) Inventors: Takayuki Hirashige, Hitachi (JP); Tomoichi Kamo, Tokai (JP); Kenji Yamaga, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/721,447

(22) PCT Filed: Dec. 14, 2004
(86) PCT No.: PCT/JP04/18613

§ 371 Date: Jun. 12, 2007

(51) Int. Cl. H01M 8/10; H01M 4/82

(52) U.S. Cl. 429/33; 29/623.5

(57) ABSTRACT

The present invention provides an electrolyte membrane with high proton conductivity and low methanol permeability, a high output MEA and DMFC. The electrolyte membrane is characterized by comprising a metal oxide hydrate having proton conductivity and an organic polymer having proton conductivity. A preferable metal oxide hydrate is zirconium oxide hydrate or tungsten oxide hydrate. The composite electrolyte membrane has an ion exchange capacity of 0.75 to 1.67 meq/g as a preferable range. The composite electrolyte membrane constituted by the metal oxide hydrate and the organic polymer is provided with high proton conductivity and low methanol permeability so that MEA for DMFC with high output is provided.

### TECHNICAL FIELD

The present invention relates to an electrolyte membrane for use in a direct methanol fuel cell and a method of manufacturing the same, a membrane•electrode assembly and a direct methanol fuel cell. Further, it relates to an electrolyte membrane for use in a solid polymer electrolyte fuel cell that uses hydrogen as fuel, a membrane•electrode assembly and a solid polymer electrolyte fuel cell.

### BACKGROUND TECHNOLOGY

In recent years, a direct methanol fuel cell (DMFC; Direct Methanol Fuel Cell) that uses methanol as fuel is focused as a power source for a substitute of a lithium ion portable secondary battery, and development thereof has been conducted vigorously.

Electrodes for a DMFC have a united structure wherein a cathode catalyst layer and an anode catalyst layer are bonded to a front and back face of an electrolyte membrane of proton conductivity. This is called a membrane•electrode assembly (MEA). The cathode catalyst layer and the anode catalyst layer are made of matrixes of mixtures of carbon carriers carrying catalysts and a solid polymer electrolyte. Electrode reactions take place at three phase interfaces where catalysts on the carbon, the solid polymer electrolyte and reactants are in contact with each other. Connection of carbon is a path for electrons and connection of the solid polymer electrolyte is a path for protons.

In the DMFC the following reactions represented by equation (1) and equation (2) take place at the anode electrode catalyst layer and the cathode catalyst layer thereby to take out electricity.

CH₃OH+H₂O→CO₂+6H⁺+6e⁻ (1)

O₂+4H⁺+4e⁻→2H₂O (2)

It is generally said that the DMFC has an energy density about ten times that of lithium secondary batteries. However, at present, the output of MEA is so low that the DMFC has not been put into practice so far.

In order to improve the output of the DMFC, there are such approaches as developments of catalysts and electrolyte membranes as constituting materials and optimization of an MEA structures. Among them, it is not too much say that improvement of the electrolyte membrane controls the output of the DMFC.

Performance characteristics required for the electrolyte membrane are high proton conductivity and low methanol permeability. The high proton conductivity is concerned with resistivity of the electrolyte membrane and the low methanol permeability is necessary to prevent so-called a crossover wherein methanol at the anode permeates the membrane and arrives at the cathode. Methanol that has arrived at the cathode reacts with oxygen on the cathode catalyst thereby to generate heat. The crossover causes increase in an over-voltage of the cathode to decrease an output of MEA.

At present, electrolyte membranes that are most widely used are perfluorosulfonic acid electrolyte membranes, which are know as Nafion (Trademark of DuPont). Nafion has side chains, which are bonded to a main chain of hydrophobic polytetrafluoroethylene (PTFE), the side chains having sulfonic acid groups at ends thereof. Ion clusters are formed by associating sulfonic acid groups and water molecules in a hydrous state. Because of a high concentration of the sulfonic groups in the clusters, the clusters become a path for protons with high proton conductivity. However, since methanol, which is soluble in water, may move through the clusters, a permeability rate of methanol becomes large. Although Nafion has a high proton conductivity, it has a problem that permeability of methanol is large.

As other electrolyte membranes than Nafion, there are hydrocarbon electrolyte membranes, aromatic hydrocarbon electrolyte membranes, etc. All of these membranes have proton donors such as sulfonic acid groups, phosphoric acid groups, carboxylic acid groups, etc. Like Nafion, these electrolyte membranes liberate protons to thereby exhibit proton conductivity when they are in a hydrous state. If the content of proton donors such as sulfonic acid groups is increased, the proton conductivity is increased. However, if the proton content is increased, water easily moves and methanol easily permeates.

As discussed above, in single electrolyte membranes of organic polymers, there is a tradeoff relation between the proton conductivity and methanol permeability; thus, it was difficult to produce electrolyte membranes with balanced high proton conductivity and low methanol permeability.

In order to obtain an electrolyte membrane with balanced proton conductivity and low methanol permeability, Patent document No. 1 proposed blocking of methanol by a palladium film or palladium alloy film sandwiched between two electrolyte membranes. Patent document No. 2 proposed an electrolyte membrane wherein pores of a polymer substrate, which is not substantially swollen with methanol and water, are filed with polymer with proton conductivity so that swelling of the polymer with proton conductivity is controlled to suppress the crossover of methanol.

Patent document No. 1: Japanese patent laid-open 2002-231256

Patent document No. 2: WO 00/54351

### DESCRIPTION OF THE INVENTION

### Problem to be Solved by the Invention

However, in the sandwich structure wherein the palladium film or palladium alloy film is sandwiched between the electrolyte membranes, an output of an MEA, which passes protons, is limited because of too much low proton conductivity. In the electrolyte membrane wherein the pores of the porous substrate are filled with the polymer having proton conductivity, the electrolyte membrane has low proton conductivity as a whole because of no proton conductivity of the porous substrate.

As discussed above, it was almost impossible to obtain an electrolyte membrane with high proton conductivity and low methanol permeability from any materials; thus, the MEA exhibits a low output.

An object of the present invention is to provide an electrolyte membrane that satisfies high proton conductivity and low methanol permeability, the MEA having high output performance for the DMFC and the DMFC using the MEA.

### Means for Achieving the Object

The present invention provides a composite electrolyte membrane comprising a metal oxide hydrate having proton conductivity and an organic polymer having proton conductivity. Particularly, it employs an organic polymer having an ion equivalent exchange of 0.75 to 1.67 meq/g per a dry base weight of the polymer.

### ADVANTAGES OF THE INVENTION

According to the electrolyte membrane of the present invention, high proton conductivity and low methanol permeability are balanced thereby to produce an MEA with high output performance for the DMFC.

### BRIEF DESCRIPTION OF DRAWINGS

FIG. 1 is a diagrammatic view of a composite electrolyte membrane of the present invention.

FIG. 2 is a cross sectional view of a fuel cell of the present invention.

FIG. 3 is an exploded perspective view of elements for the fuel cell of the present invention.

FIG. 4 is an outer view of the fuel cell of the present invention.

FIG. 5 is a graph showing a relationship between proton conductivity and humidity.

FIG. 6 is a graph showing a relationship between methanol permeability current density and voltage.

FIG. 7 is a graph showing a relationship between voltage and current density.

### EXPLANATION OF REFERENCE NUMERALS

11; organic polymer, 12; metal oxide hydrate, 21; separator, 22; composite electrolyte membrane of the present invention, 23; anode catalyst layer, 24; cathode catalyst layer, 25; gas diffusion layer, 26; gasket, 31; fuel chamber, 32; anode end plate, 33; gasket, 34; MEA with gas diffusion layers, 35; cathode endplate, 36; terminal, 37; cartridge holder, 38; screw, 44; connecting terminal, 45; exhaust gas port, 46; output terminal, 48; fuel cartridge

### BEST EMBODIMENTS FOR PRACTICING THE INVENTION

Embodiments of the present invention will be explained in detail by reference to drawings.

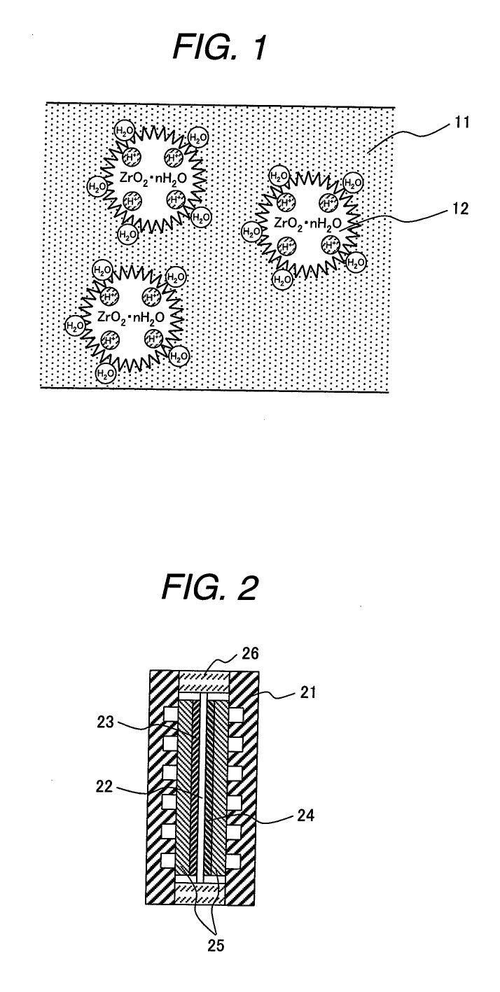

FIG. 1 shows a model of the electrolyte membrane according to the present invention. In the drawing, numeral 11 denotes an organic polymer having proton donors such as sulfonic acid groups and numeral 12 denotes metal oxide hydrate having proton conductivity. Here, the metal oxide hydrate is zirconium oxide hydrate ZrO₂.nH₂O.

The organic polymer exhibits proton conductivity in a hydrous state (water containing state). In the hydrous state, protons are liberated from the proton donors such as sulfonic acid groups to travel. When the organic polymer is used in the DMFC, methanol, which has the same size as water and mutually dissolves in water, methanol also travels through the polymer.

On the other hand, in the metal oxide hydrate, protons travel by means of hydrous water in the crystals. The hydrous water in the crystals does not move because they are fixed in the crystals. Since mobility of water and methanol is closely linked, methanol does not move in the portion where water does not move. Further, metal oxide hydrate has relatively high proton conductivity among inorganic substances. For example, zirconium oxide hydrate ZrO₂.nH₂O has proton conductivity of 2.8×10⁻³ S/cm and tin oxide hydrate SnO₂ nH₂O has 4.7×10⁻³ at 25° C., respectively.

Accordingly, it is possible to obtain a composite electrolyte membrane by combining the organic polymer and inorganic polymer each having a different conductivity mechanism so that methanol is blocked and protons can travel through the membrane. According to the present invention, the tradeoff relation between proton conductivity and methanol permeability observed in the single organic polymer electrolyte membrane can be improved.

The metal oxide hydrate has humidity retention because it has hydrous water in the crystal. When the metal oxide hydrate is dispersed in the organic polymer, the electrolyte membrane has humidity retention as a whole. If the composite electrolyte membrane is used for a polymer electrolyte fuel cell (PEFC), an operating temperature can be elevated to a temperature higher than 70 to 80° C. In the case where a conventional single polymer electrolyte membrane is used, water vaporizes from the membrane at high temperatures thereby to lower the proton conductivity. That is, 70 to 80° C. was an upper limit of operation temperature.

On the other hand, since the composite electrolyte membrane, which has metal oxide hydrate dispersed in the polymer electrolyte, has humidity retention performance, it is possible to prevent lowering of proton conductivity at high temperatures. An increase of operating temperature brings about an increase in an output, reduction of noble metal catalyst, effective utilization of exhaust heat, etc.

Japanese patent laid-open 2002-198067 and Japanese patent laid-open 2002-289051 disclose as an electrolyte membrane for a high temperature operation PEFC composite electrolyte membranes comprising tungsten oxide, molybdenum oxide or tin oxide and a polymer. As a result, the operating temperature of the PEFC is elevated to about 100° C. The composite electrolyte membrane according to the present invention may be applied to an electrolyte membrane for high temperature operating type PEFC.

As metal oxide hydrates that exhibits proton conductivity there are zirconium oxide hydrate, tungsten oxide hydrate, tin oxide hydrate, niobium doped tungsten hydrate, silicon oxide hydrate, oxo-phosphoric acid hydrate, zirconium doped silicon oxide hydrate, tungstophosphoric acid, molybdophosphoric acid, etc. Mixtures of the above substances can be used. As the electrolyte membrane for high temperature operating type PEFC, zirconium oxide is particularly suitable.

As organic polymers perfluorocarbon sulfonic acid, polystyrene, polyetherketone, polyetheretherketone, polysulfone, polyethersulfones, and other engineering plastic materials are chemically bonded or doped with proton donors such as sulfonic acid groups, phosphoric acid groups. The above materials can be partially modified with fluorine atoms thereby to stabilize them.

In the composite electrolyte membrane composed by the metal oxide hydrate having proton conductivity and the organic polymer, the organic polymer should have a proper hydrophilic property. Since the metal oxide hydrate has hydrous water, affinity between the metal oxide hydrate and the polymer becomes worse if the polymer is not hydrophilic. If the affinity is not good, the metal oxide hydrate agglomerates and dispersing property thereof becomes worse, which makes it difficult to make a membrane.

Hydrophilic property of the organic polymer is determined by a concentration of the ion exchange groups such as sulfonic acid groups or carboxylic acid groups, etc. A parameter of the ion exchange group concentration is expressed by an ion exchange capacity q (meq/g); the larger the ion exchange capacity, the higher the ion exchange group concentration becomes high.

The ion exchange capacity is measured by H-NMR spectroscopy, element analysis, acid-base titration, non-hydroxy acid base titration (a titrant solution is a benzene-methanol mixed solution of potassium methoxide), etc. The ion exchange capacity, which gives such a sufficient hydrophillic property as to homogeneously disperse the metal oxide hydrate, is preferably 0.75 meq/g or more of the dry base of the organic polymer. Especially, 1.0 meq/g or more is preferable. When the ion exchange capacity is large, it easily dissolves in methanol to shorten the life. Accordingly, the ion exchange capacity should be 1.67 meq/g or less on the dry base of the organic polymer. Especially, 1.4 meq/g or less is more preferable.

When a content of the metal oxide hydrate dispersed in the organic polymer is 5% by weight or less, an effect is not expected. When the content is 80% by weight or more, the metal oxide hydrate tends to agglomerate and film making becomes difficult. Accordingly, the content is 5 to 80% by weight is preferable, more preferably, 10 to 60% by weight.

As a method of manufacturing the composite electrolyte membrane comprising the metal oxide hydrate and the organic polymer, a simple dispersion method and a precursor dispersion method may be employed. The simple dispersion method comprises a step for preparing the metal oxide hydrate, a step for dissolving the organic polymer in a solvent to make a varnish, a step for mixing the metal oxide hydrate and the varnish, and a step for casting the mixture on a substrate to make a film.

The precursor dispersion method comprises a step for mixing a varnish in which a metal oxide hydrate precursor is dissolved in a solvent and a varnish in which the organic polymer is dissolved in a solvent, a step for casting the mixture on a substrate to make a film, and a step for precipitating the metal oxide hydrate by reacting the precursor in the film after casting the mixture. In view of the dispersibility of the metal oxide hydrate, the precursor dispersion method is preferable.

The method for film making is not limited; a dip casting method, spray casting method, roller casting method, doctor blade method, gravure casting method, screen printing method, etc may be employed. As the substrate any materials are used as long as the film is peeled off. For example, glass plate, PTFE sheet, polyimide sheet, etc are used. Mixing methods are carried out by a stirrer, ball mil, etc.

Solvents for dissolving the organic polymer are not limited as long as it dissolves the organic polymer and is removed thereafter. For example, there are non-proton polar solvents such as N,N-dimethylformamide, N,N-dimethylacetamide, N-methylpyrrolidone, dimethylsulfoxide, etc, alkyleneglycol monoalkylethers such as ethyleneglycol monomethylether, ethyleneglycol monoethylether, propyleneglycol monomethylether, propyleneglycol monoethylether, etc, halogen solvents such as dichloromethane, trichloroethane, etc, and alcohols such as i-propyl alcohol, t-butyl alcohol, etc.

A thickness of the composite electrolyte membrane according to the present invention is not particularly limited, but 10 to 200 μm is preferable. A thickness of 10 μm or more is necessary to secure mechanical strength of the membrane for practical use; in order to reduce the membrane resistance, which leads to an increase in electricity generation efficiency, the thickness should be 200 μm or less. Particularly, a thickness of 30 to 100 μm is preferable.

In case of a solution casting method, the thickness of the film is controlled by a concentration of the solution or a thickness of casting. In case of a melting method, the thickness is controlled by selecting an expanding rate of a film having a predetermined thickness, which is prepared by a melting press method or a melting extrusion method.

MEA of the present invention including the composite electrolyte membrane can be prepared by the following method, for example. At first, a cathode catalyst paste comprising carbon that carries platinum, a solid polymer electrolyte and a solvent for dissolving the polymer electrolyte is prepared; an anode catalyst paste comprising carbon that carries platinum-ruthenium alloy, a solid polymer electrolyte and a solvent for dissolving the solid polymer is prepared. These pastes are cast on a separating film by a spray-dry method, followed by drying at 80° C. to vaporize the solvents to form a cathode catalyst layer and anode catalyst layer. The cathode catalyst layer and anode catalyst layer are bonded by a hot-press method to the composite electrolyte membrane of the present invention by sandwiching it with the catalyst layers. At last, the separating film is peeled off.

As another method, the cathode catalyst paste of a mixture prepared by thoroughly mixing the carbon that carries platinum, the solid polymer and the solvent and the anode catalyst paste of a mixture prepared by thoroughly mixing the carbon that carries platinum-ruthenium alloy, the solid polymer and the solvent are cast by the spray-dry casting method directly on the composite electrolyte membrane of the present invention.

As the solid polymer electrolyte contained in the catalyst layers, materials having proton conductivity are used; for example, there are sulfonated or alkylsulfonated fluorine containing polymers represented by perfluorocarbon type sulfonic acid resin or polyperfluorostyrene sulfonic acid resin or polystyrene resin. Further, there are polysulfones, polyetherether sulfones, polyetheretherketones and hydrocarbon polymers into which proton donors are introduced. Further, as a solid polymer electrolyte contained in the catalyst layers, a composite electrolyte of the present invention comprising an organic polymer having proton conductivity and a metal oxide hydrate having proton conductivity can be used.

On the other hand, preferable are as catalyst metals at least platinum for a cathode side and at least platinum or platinum-ruthenium alloy for an anode side are preferable. However, the scope of the present invention is not limited to the above-mentioned noble metals. In order to stabilize the catalysts or to extend the life of the catalysts, a second element selected from iron, tin and rare earth metals may be added to the noble metals.

FIG. 2 shows an example of a methanol fuel cell according to the present invention. In FIG. 2, numeral 21 denotes a separator, 22 a composite electrolyte membrane of the present invention, which is constituted by a metal oxide hydrate having proton conductivity and an organic polymer having proton conductivity, 23 an anode catalyst layer, 24 a cathode catalyst layer, 25 a gas diffusion layer and 26 a gasket. MEA is prepared by bonding the anode catalyst layer 23 and cathode catalyst layer 24 onto the composite electrolyte membrane 22. A separator 21 has electrical conductivity, which is made of dense graphite plate, carbon plate formed from carbon material such as graphite or carbon black and resin or metal material with good corrosion resistance such as stainless steel or titanium, etc. A surface of the separator 21 can be plated with a noble metal or cast with an electrically conductive paint with good corrosion resistance and heat resistance. The separator 21 is provided with grooves on the surfaces facing the anode catalyst layer 23 and cathode catalyst layer 24, fuel being supplied through the grooves and air being supplied through the grooves.

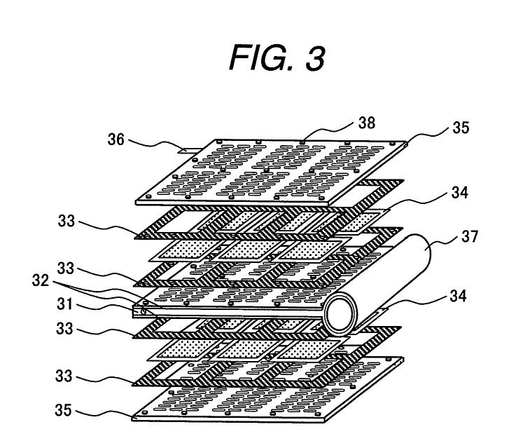

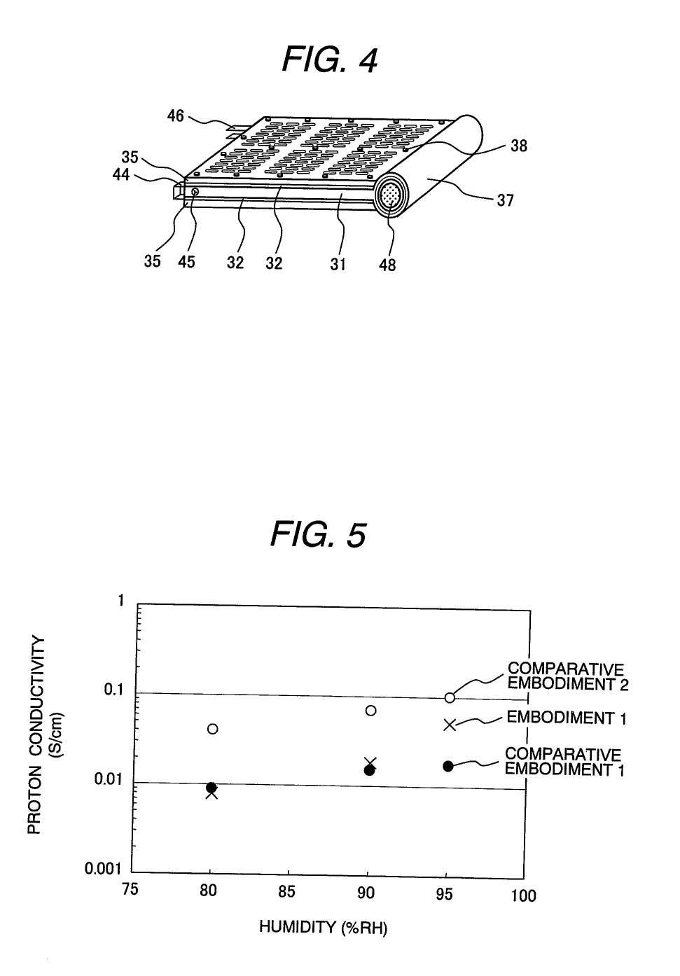

Using MEA comprising the composite electrolyte membrane prepared by the metal oxide hydrate with proton conductivity and the organic polymer with proton conductivity, a methanol fuel cell for portable electronic devices can be assembled. FIGS. 3 and 4 show a fuel cell designed for PDA (Personal Digital Assistant). FIG. 3 shows constituting components.

An anode end plate 32, gasket 33, MEA 34 with diffusion layers, gasket 33 and cathode end plate 35 were stacked in the order on both faces of the a fuel chamber with a cartridge holder 37, and the stack was united and fixed by screws 38 to keep substantially uniform pressure force in a plane thereby to constitute a fuel cell. The anode end plate and cathode end plate are respectively provided with terminals 36, to thereby take out electricity.

FIG. 4 shows an outer view of the fuel cell constituted by the elements shown in FIG. 3. A plurality of MEAs is connected in series on both sides of the fuel chamber 31, both of the MEA groups in series connection on both sides being connected in series by means of connecting terminal 44 to thereby take out electricity through the output terminal 46. In case of FIG. 4, there are 12 rows. In FIG. 4, a methanol aqueous solution is supplied under pressure from cartridge 48 by high pressure liquefied gas, a high pressure gas or a spring. CO₂ generated at the anode is discharged from exhaust port 45. The exhaust port 45 has a function for gas-liquid separation, which passes gas, but does not pass liquid.

On the other hand, air as an oxidizing agent is supplied by diffusion through air diffusion slits of the cathode end plate 32, and water produced at the cathode is diffused and discharged through the slits.

A method for fastening the fuel cell is not limited to the screw fastening method; the fuel cell is inserted into a casing whereby the fuel cell is fastened by constraining force from the casing.

In the following, the present invention will be explained by reference to embodiments. The scope of the present invention is not limited to the following embodiments.

### Embodiment 1

As the metal oxide hydrate, zirconium oxide hydrate ZrO₂ nH₂O was used. As the organic polymer, S-PES (sulfonated-poly ether sulfone) was used, which has an ion exchange capacity of 1.3 meq/g on the dry base.

The precursor dispersion method was employed to produce the composite electrolyte membrane. As the precursor of the zirconium oxide hydrate ZrO₂.nH₂O, zirconium oxychloride octahydrate ZrOCl₂.8H₂O was used.

At first, ZrOCl₂.8H₂O was dissolved in dimethyl sulfoxide to prepare a varnish of the precursor. A concentration of the precursor was 30% by weight. The two varnishes were mixed and stirred by a stirrer. Thereafter, the varnish was cast by an applicator on glass plate, and the film was dried in a vacuum dryer at 80° C. for 1 hour and 120° C. for 3 hours to vaporize dimethyl sulfoxide solvent. Then, the dried film was peeled off from the glass plate and the film was dipped in a 25% NH₃ aqueous solution so as to carry out the following reaction in the film.

ZrOCl₂.8H₂O+(n+1)H₂O→ZrO₂.nH₂O+2H⁺+2Cl⁻

The film was immersed in a 0.5 M KOH aqueous solution to remove Cl⁻ and was rinsed with water. At last, the film was immersed in a 1M H₂SO₄ aqueous solution thereby to effect protonation to obtain S-PES (ion exchange capacity; 1.3 meq/g) wherein ZrO₂.nH₂O was dispersed in the film. The resulting electrolyte membrane was homogeneously white as a whole, and a thickness was 50 μm.

Proton conductivity of the composite electrolyte membrane was measured at 70, 80, 90 and 95% RH. Methanol permeability of the composite electrolyte membrane was measured by an electro-chemical method after the membrane was assembled into the MEA.

MEA was assembled in the following manner. As a cathode catalyst platinum carrying carbon TEC10V50E (Pt carried amount: 50% by weight) manufactured by Tanaka Noble Metal Corp., as anode catalyst platinum-ruthenium carrying carbon TEC61V54 (Pt carried amount: 29% by weight, Ru carried amount: 23% by weight) manufactured by Tanaka Noble Metal Corp. were used. To these catalysts added were water and Nafion 5% by weight solution manufactured by Aldrich; the mixtures were mixed and stirred to prepare catalyst slurries.

Weight ratios of the slurries were shown below.

Cathode; TEC10V50E:water:5 wt % Nafion solution=1:1:8.46.

Anode; TEC10V50E:water:5 wt % Nafion solution=1:1:7.9.

These catalyst slurries were separately cast by an applicator on PTFE sheet to prepare an anode catalyst layer and a cathode catalyst layer. Thereafter, the MEA was prepared by hot-pressing to transfer the anode catalyst layer and cathode layer onto the composite electrolyte membrane. Amounts of catalysts were 1.8 mg/cm² of the anode catalyst PtRu and 1.2 mg/cm² of the cathode catalyst.

The resulting cathode catalyst layer was a working electrode and the anode was a counter electrode; nitrogen gas was flown to the working electrode at a flow rate of 100 ml/min, and the counter electrode was filled with a methanol aqueous solution. A potential of 0.1 to 0.8 V was applied between the working electrode and the counter electrode. Methanol permeated to the working electrode was oxidized and current that flows at the time of oxidation of methanol was measured. I-V characteristics of used MEA were measured based on amounts of permeated methanol. A measuring cell shown in FIG. 2 was used. Air was supplied to the cathode by natural aspiration, and a methanol aqueous solution was supplied to the anode at a flow rate of 10 ml/min. A concentration of the methanol aqueous solution was 10% by weight.

### Comparative Embodiment

As the electrolyte membrane S-PES (ion exchange capacity; 1.3 meq/g) was used. S-PES (ion exchange capacity; 1.3 meq/g) was dissolved in dimethyl sulfoxide to prepare a varnish. A concentration of the varnish was 30% by weight. The varnish was cast by an applicator on glass plate, and the film was dried by a vacuum dryer at 80° C. for 1 hour and 120° C. for 3 hours to vaporize dimethyl sulfoxide solvent. Thereafter, the film was peeled off from the glass plate; then it was immersed in a 1M H₂SO₄ aqueous solution for one night to make protonation thereby to make a single electrolyte membrane of S-PES (ion exchange capacity; 1.3 meq/g). The resulting electrolyte membrane was white and a thickness was 50 μm.

Proton conductivity of the resulting electrolyte membrane was measured under the same conditions as in Embodiment 1. The MEA was prepared in the same manner and under conditions as in embodiment 1 to measure methanol permeability. Using this MEA, V-I characteristics were measured under the same condition as in embodiment 1.

### Comparative Embodiment 2

As an electrolyte membrane Nafion 112 (thickness; about 50 μm) manufactured by duPont was used. Proton conductivity was measured under the same conditions as in embodiment 1. An MEA using Nafion 112 was prepared in the same manner and under the same conditions as in embodiment 1. Methanol permeability and V-I characteristics of the MEA were measured under the same conditions as in embodiment 1.

FIG. 5 shows methanol permeability of the MEA in embodiment 1, comparative embodiments 1 and 2. In 95% RH, the single electrolyte membrane S-PES (ion exchange capacity; 1.3 meq/g) in Comparative embodiment 1 exhibited 0.0175 S/cm, but the composite electrolyte membrane in embodiment 1 wherein ZrO₂.nH₂O was dispersed exhibited 0.051 S/cm, which was increased to three times. This value was equal to 50% or more of 0.1 S/cm of Nafion in comparative embodiment 2.

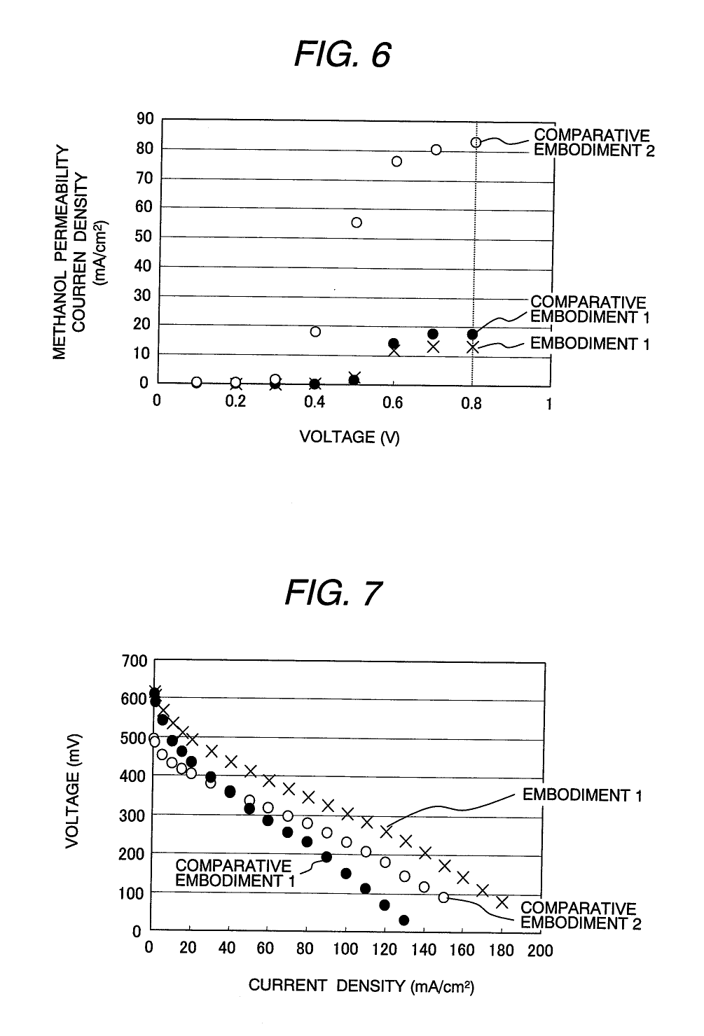

FIG. 6 shows methanol permeability of the MEA in embodiment 1, comparative embodiment 1 and comparative embodiment 2. The smaller the methanol permeability current density, the smaller the methanol permeability is obtained. At a voltage below 300 mV since the voltage is not so high as to advance oxidation reaction of methanol, methanol permeability current hardly flows. Over 400 mV, methanol permeability current starts to gradually flow.

At a voltage of 800 mV or more the methanol permeability current becomes constant. The currents at 800 mV were compared as the methanol permeability current density. If the current density of Nafion is set to be 1, the current density of embodiment 1 was 0.16 and the current density of comparative embodiment 1 was 0.21.

From the above results, it is concluded that the S-PES (ion exchange capacity; 1.3 meq/g) in embodiment 1 wherein ZrO2.nH₂O was dispersed exhibited a methanol permeability smaller than that of S-PES (ion exchange capacity; 1.3 meq/g) in comparative embodiment 1 and proton conductivity of the embodiment remarkably increased.

Further, compared with Nafion 112 in comparative embodiment 2, the trade-off found in the single electrolyte membrane was improved. That is, though the proton conductivity of the membrane in embodiment 1 was about 50% that of Nafion 112, but the degree of methanol permeability in embodiment was suppressed to ⅙ of that of Nafion 112.

FIG. 7 shows V-I characteristic data of embodiment 1, comparative embodiments 1 and 2. In embodiment 1, the MEA exhibited the highest voltage in the three and the highest output in the three. The maximum output was 31 mW/cm² at a current density of 120 mA/cm² in embodiment 1. On the other hand, in comparative embodiment 1 using the single electrolyte membrane of S-PES (ion exchange capacity; 1.3 meq/g), the maximum output was 18 mW/cm² at a current density of 80 mA/cm². In comparative embodiment 2 using Nafion 112, the maximum output was 23 mW/cm at a current density of 100 mA/cm².

In case of embodiment 1, since a voltage drop caused by methanol crossover is smaller than that of Nafion 112 in comparative embodiment 2, a higher voltage and high output were generated. Further, in comparative embodiment 1 using the single electrolyte membrane S-PES (ion exchange capacity; 1.3 meq/g), though a voltage drop caused by the methanol crossover was small, a voltage drop caused by an IR drop due to membrane resistance was observed because of bad proton conductivity at high temperatures.

### Embodiment 2

As the metal oxide hydrate the zirconium oxide hydrate ZrO₂.nH₂O was used and as the organic polymer S-PES (ion exchange capacity; 1.3 meq/g) was used. The precursor dispersion method was employed to produce the composite electrolyte membrane. As the precursor of the zirconium oxide hydrate ZrO₂.nH₂O, zirconium oxychloride octahydrate ZrOCl₂.8H₂O was used. The method of the membrane was the same as in embodiment 1. Contents of ZrO₂.nH₂O were 10% and 30% by weight. In case of 10%, the membrane was transparent and in case of 30%, the membrane was white.

Proton conductivity was measured under the same conditions as in embodiment 1. The MEA was prepared in the same manner and under the same conditions as in embodiment 1 and methanol permeability amount and I-V characteristics were measured. In Table 1, there shown proton conductivity, methanol permeability rates with respect to 1 for methanol permeation current density of Nafion 112 and maximum output. For the purpose of comparison, data of embodiment 1 and of comparative embodiment 1 are shown in Table 1.

When an amount of ZrO₂.nH₂O is 10% by weight, effects of dispersed ZrO₂.nH₂O were hardly observed; the data was almost the same as those of the single electrolyte membrane of S-PES. In case of 30% by weight of ZrO₂.nH₂O, the proton conductivity was increase to about 1.6 times that of S-PES single electrolyte membrane. On the other hand, the methanol permeability became almost the same level as in comparative embodiment. This means that the trade-off relation between the proton conductivity and the methanol permeability was improved by dispersing ZrO₂.nH₂O, which is not so remarkable as in 50% by weight dispersion of ZrO₂.nH₂O. The maximum output was 22 mW/cm², which is 1.2 times that of S-PES in comparative embodiment 1.

TABLE 1

| | | | | Comparative |
|---|---|---|---|---|
| | Embodiment 2 | Embodiment 2 | Embodiment 1 | embodiment 1 |
| Content of | ZrO₂•nH₂O = | ZrO₂•nH₂O = | ZrO₂•nH₂O = | S-PES single |
| ZrO₂•nH₂O | 10 wt % | 30 wt % | 50 wt % | electrolyte |
| | | | | membrane |
| Proton | 0.017 | 0.028 | 0.051 | 0.017 |
| conductivity | | | | |
| (S/cm) | | | | |
| 95% RH at 70° C. | | | | |
| Methanol | 0.2 | 0.17 | 0.18 | 0.21 |
| permeability | | | | |
| (Permeability | | | | |
| current of | | | | |
| NAFION 112 being | | | | |
| 1) | | | | |
| Maximum output | 17 | 22 | 31 | 18 |
| (mW/cm²) | | | | |

### Embodiment 3

As the metal oxide hydrate, zirconium oxide hydrate ZrO₂.nH₂O and as the organic polymer S-PES (ion exchange capacity; 1.3 meq/g) were used. A method of preparing the membrane was a simple dispersion method. ZrO₂.nH₂O was prepared in the following manner.

At first, 16.1 g (0.05 mol) of oxy-zirconium chloride ZrOCl₂.8H₂O was dissolved in 50 ml of water. Added to the solution was 25 wt % of NH₃ aqueous solution thereby to carry out the following dialysis reaction.

ZrOCl₂.8H₂O+(n+1)H₂O→ZrO₂.nH₂O+2H⁺+2Cl⁻

Next, the precipitate was separated by filteration, and was washed with a 0.5M KOH aqueous solution to remove Cl⁻ ions. Thereafter, the precipitate was rinsed with pure water, followed by drying in a desiccator to obtain white powder of ZrO₂.nH₂O.

On the other hand, S-PES (ion exchange capacity; 1.3 meq/g) was dissolved in dimethyl sulfoxide to make a varnish. A content of the solute was 30% by weight.

ZrO₂.nH₂O was added to the varnish, and the mixture was stirred for 2 hours. Then, the mixture was cast with an applicator on glass plate. The casting was dried in a vacuum dryer at 80° C. and 120° C. for 3 hours to remove dimethyl sulfoxide solvent.

Thereafter, the casting was immersed in a 1MH₂SO₄ aqueous solution for one night to effect protonation thereby to produce an ion exchange membrane wherein ZrO₂.nH₂O is dispersed in the S-PES (ion exchange capacity; 1.3 meq/g). A content of ZrO₂.nH₂O was 10, 30 and 50 wt %. White particles were dispersed throughout the resulting electrolyte membrane. This was caused by agglomeration of ZrO₂.nH₂O, which means that the dispersion state was not good.

Proton conductivity of the electrolyte membranes were measured under the same conditions as in embodiment 1. MEAs using the membranes were prepared in the same manner and under the same conditions as in embodiment 1. Using the MEAs, methanol permeability and I-V characteristics were measured.

There are shown proton conductivity, methanol permeability rate based on the methanol permeable current density of Nafion 112 being 1 and the maximum output. When a content of ZrO₂.nH₂O is 10 wt %, the data was almost the same as that of comparative embodiment 1. As the content of ZrO₂.nH₂O increases to 30 wt % and 50 wt %, the methanol permeability increased, though the proton conductivity was same; this may be because as the content of ZrO₂.nH₂O increases, ZrO₂.nH₂O tends to agglomerate. Agglomerated ZrO₂.nH₂O produced gaps between particles so that the methanol permeability increased.

TABLE 2

| | Embodiment 3 | Embodiment 3 | Embodiment 3 |
|---|---|---|---|
| Content of ZrO₂•nH₂O | ZrO₂•nH₂O = | ZrO₂•nH₂O = | ZrO₂•nH₂O = |
| | 10 wt % | 30 wt % | 50 wt % |
| Proton conductivity | 0.016 | 0.018 | 0.017 |
| (S/cm) | | | |
| Humidity 95% RH at | | | |
| 70° C. | | | |
| Methanol | 0.2 | 0.25 | 0.5 |
| permeability | | | |
| (permeable current | | | |
| density of Nafion | | | |
| 112 being 1) | | | |
| Maximum output | 17 | 20 | 16 |
| (mW/cm²) | | | |

### Embodiment 4

As the metal oxide hydrate ZrO₂.nH₂O was used; as the organic polymer S-PES (ion exchange capacity was used; 1.51, 0.91, 0.86, 0.77 meq/g) and PES free from sulfone groups were used. The method of preparing the membranes was the same as in embodiment 1. The content of ZrO₂.nH₂O was 50 wt %.

In case of PES, a film could not be made because it became crumbly. This is because PES has no sulfone groups, which are hydrophilic, PES and ZrO₂.nH₂O separated into two phases.

In case of S-PES of ion exchange capacity of 0.77 meq/g, though filming was possible, separation of white portions and transparent portions was observed. It is considered that because the S-PES having the ion exchange capacity of 0.77 meq/g has a high hydrophobic property, dispersion of ZrO₂.nH₂O was bad. In cases of S-PES having an ion exchange capacity of 1.51, 0.91 and 0.85 meq/g, homogeneous, white electrolyte membranes were obtained.

Proton conductivity of the electrolyte membranes were measured under the same conditions as in embodiment 1. MEAs using the electrolyte membranes were prepared in the same manner and under the same conditions as in embodiment 1. Using the resulting MEAs, methanol permeability rates and I-V characteristics were measured. Table 3 shows proton conductivity and methanol permeability based on the methanol permeability of Nafion 112 being 1. In case of S-PES having the ion exchange of 1.51 meq/g, though the proton conductivity is high, the methanol permeability was high. This was because the content of sulufone groups was so high that dispersed ZrO₂.nH₂O could not block the sulfone groups.

Further, the smaller the ion exchange capacity, the smaller the proton conductivity became small and the methanol permeability increased. At the same time, the output was small. This is because as the ion exchange capacity of S-PES decreases, hydrophobic property of S-PES becomes stronger and the dispersing property of ZrO₂.nH₂O may become worse.

TABLE 3

| | Embodiment 4 | | | | |
|---|---|---|---|---|---|
| Ion exchange capacity of | 1.51 | 0.91 | 0.85 | 0.77 | PE |
| S-PES(meq/g) | | | | | |
| Proton | 0.06 | 0.044 | 0.02 | 0.018 | Not |
| conductivity(humidity; | | | | | filmed |
| 95% RH at 70° C.) | | | | | |
| Methanol | 0.6 | 0.3 | 0.4 | 0.5 | |
| permeability(Methanol | | | | | |
| permeability of Nafion | | | | | |
| 112 being 1) | | | | | |
| Maximum output(mW/cm2) | 22 | 25 | 18 | 16 | |

### Embodiment 5

As the metal oxide hydrate, tin oxide hydrate SnO₂.2H₂O was used and as the organic polymer, S-PES (ion exchange capacity; 1.3 meq/g) was used. The membrane was prepared by the precursor dispersion method. As the precursor of SnO₂.2H₂O, SnCl₄.5H₂O was used. At first, SnCl₄.5H₂O was dissolved in dimethyl acetamide to prepare a varnish. A concentration of the solute was 30 wt %.

The two kinds of varnishes were mixed and stirred with a stirrer for 2 hours. Thereafter, the mixture was cast with an applicator on glass plate, and the casting was dried in a vacuum dryer at 80° C. for 1 hour and at 120° C. for 3 hours to evaporate dimethyl acetamide solvent Then, the casting was peeled off from the glass plate and immersed in a 25 wt % NM₃ aqueous solution thereby to advance the following reaction.

SnCl₄.5H₂O→SnO₂.2H₂O+4H⁺+4Cl⁻+H₂O

The casting was immersed in a 0.5M KOH aqueous solution to remove Cl⁻ ions and rinsed with water. At last, it was immersed in a 1M H₂SO₄ aqueous solution thereby to effect protonation to obtain S-PES membrane (ion exchange capacity; 1.3 meq/g) wherein SnO₄.2H₂O was dispersed. A content of SnO₄.2H₂O was 50 wt %. The membrane was white.

Proton conductivity of the resulting membrane was measured under the same conditions as in embodiment 1. The MEAs were prepared using the membrane in the same manner and under the same conditions as in embodiment. Using the MEAs, methanol permeability rate and I-V characteristics were measured. As a result, the proton conductivity in 95% RH at 70° C. was 0.033 S/cm. Compared with the single electrolyte membrane made of S-PES of comparative embodiment 1, the proton conductivity was increased to two times. Further, the methanol permeability was 0.2, based on the methanol permeability of Nafion 112 being 1.

The membrane according to the present invention has almost the same methanol permeability of comparative embodiment 1, and the proton conductivity was about two times that of comparative embodiment 1. Therefore, the trade-off relationship between the proton conductivity and methanol permeability was improved. The maximum output was 28 mW/cm².

### Embodiment 6

As the metal oxide hydrate, tungsten oxide 2-hydrate WO₃.2H₂O was used and as the organic polymer, S-PES (ion exchange capacity; 1.3 meq/g) was used. WO₃.2H₂O was prepared in the following manner. 50 ml of a 1.0M Na₂WO₃ aqueous solution was gradually dropped under stirring with a magnetic stirrer to 450 ml of 3N HCl cooled to 5° C. to obtain yellowish precipitate.

After a supernatant was removed, 300 ml of 0.1N HCl was added to the precipitate and the mixture was stirred for ten minutes. After leaving it to effect precipitation, it was left for 24 hours as it is. The supernatant of the solution was dumped after the powder completely precipitated, the same amount of fresh pure water was added. This washing step was repeated 6 times so as to remove impurity ions coming from unreacted raw materials. Thereafter, the precipitate was filtered to obtain yellowish WO₃.2H₂O powder.

On the other hand, S-PES (ion exchange capacity; 1.3 meq/g) was dissolved in dimethyl acetamide to obtain a varnish. WO₃.2H₂O was added to the varnish and the mixture was stirred with a stirrer for 2 hours. Thereafter, the solution was cast with an applicator on glass plate and the casting was dried in a vacuum dryer at 89° C. for 1 hour and at 120° C. for 3 hours to vaporize dimethyl acetamide solvent. A content of WO₃.2H₂O was 50 wt %. The resulting electrolyte membrane was light yellowish with yellowish spots as a whole.

The proton conductivity of the electrolyte membrane was measured under the same conditions as in embodiment 1. Using the MEAs, methanol permeability and I-V characteristics were measured. As a result, the proton conductivity in 95% RH at 70 degrees was 0.025 S/cm. This value is about 1.5 times that of the S-PES (ion exchange capacity; 1.3 meq/g) single electrolyte membrane of comparative embodiment 1. The methanol permeability was 0.25 based on that of Nafion 112 being 1. Becasu of agglomeration of WO₃.2H₂O, the methanol permeability slightly increased, but the value is almost the same as that of the single membrane of S-PES. On the other hand, the proton conductivity became twice that of S-PES; the tradeoff relationship between the proton conductivity and methanol permeability was improved. The maximum output was 24 mW/cm².

### Embodiment 7

As the metal oxide hydrate, zirconium oxide hydrate ZrO₂.nH₂O was used, and as the organic polymer, S-PES (ion exchange capacity; 1.3 meq/g) was used. A composite electrolyte membrane was prepared in the same manner and under the same conditions as in embodiment 1. A content of ZrO₂.nH₂O was 50 wt %.

Using this composite electrolyte membrane, MEAs were prepared in the same manner and under the same conditions as in embodiment 1. A size of the catalyst layer was 24 mm×27 mm. This MEA was assembled into a DMFC for a PDA shown in FIG. 4. Fuel was a 10 wt % methanol aqueous solution. The maximum output at room temperature was 2.2W.

### Comparative Embodiment 3

An MEA using Nafion 112 was prepared in the same manner and under the same conditions as in embodiment 1. A size of the catalyst layer was 24 mm×27 mm. This MEA was assembled into DMFC for the PDA. As fuel, a methanol aqueous solution of a concentration of 10 wt % was used.

### Embodiment 8

The composite electrolyte membrane comprising the metal oxide hydrate and the organic polymer was used for a PEFC. As the metal oxide hydrate, zirconium oxide hydrate ZrO₂.nH₂O was used, and as the organic polymer, S-PES (ion exchange capacity; 1.3 meq/g) was used. A composite electrolyte membrane was prepared in the same manner and under the same conditions as in embodiment 1. A content of ZrO₂ nH₂O was 50 wt %.

An MEA was prepared using the composite electrolyte membrane. The MEA was prepared in the following manner.

As a cathode catalyst and an anode catalyst, carbon that carries platinum TEC10V50E (Pt carrying amount; 50 wt %) was used. Water and Nafion solution (5 wt %) manufactured by Aldrich were added to the catalyst material, and the resulting mixture was mixed and stirred to prepare a catalyst slurry. The weight ratio of components in the catalyst slurry was TEC10V50E:water:5 wt % Nafion=1:1:8.

The catalyst slurry was cast with an applicator on a PTFE sheet to make a cathode catalyst layer and an anode catalyst layer. The layers were subjected to hot pressing thereby to transfer the cathode catalyst layer and the anode catalyst layer on the composite electrolyte membrane to make MEA. A Pt content of the catalyst layers was 0.3 mg/cm². A size of the catalyst layers was 3 cm×3 cm.

The resulting MEA was assembled into a measuring cell shown in FIG. 2. As reactant gases, hydrogen to the anode and air to the cathode were supplied to the measuring cell, wherein the gases were humidified with a water bubbler at one atmospheric pressure at 90° C. Amounts of gasses were 50 ml/min of hydrogen and 200 ml/min of air. A cell temperature was 110° C. A cell voltage at a current density of 500 mA/cm2 was measured. The result was 580 mV.

### Comparative Embodiment 4

Using Nafion 112 manufactured by dupont, an MEA for the PEFC was prepared. A method of manufacturing the MEA and conditions were the same as in embodiment 8. Using this MEA, an output of the cell shown in FIG. 2 was measured. Measuring conditions were the same as in embodiment 8. A cell voltage at a current density of 500 mA/cm2 was measured; the result was 180 mV. In case of the MEA using the composite electrolyte membrane comprising zirconium hydrate ZrO₂.nH₂O and S-PES, PEFC showed a high output at such a high operating temperature as 110° C.

### INDUSTRIAL APPLICABILITY

According to the present invention, it is possible to provide an electrolyte membrane with both high proton conductivity and low methanol permeability so that an output of DMFC can be increased.

1. A composite electrolyte membrane for a DMFC, characterized by comprising a metal oxide hydrate having proton conductivity and an organic polymer having proton conductivity.

2. The composite electrolyte membrane according to claim 1, wherein the organic polymer is an aromatic hydrocarbon electrolyte.

3. The composite electrolyte membrane according to claim 1, wherein an ion exchange capacity of the organic polymer is 0.75 to 1.67 meq/g on the dry base.

4. The composite electrolyte membrane according to claim 1, wherein the metal oxide hydrate is zirconium oxide hydrate, tin oxide hydrate or tungsten oxide hydrate.

5. The composite electrolyte membrane according to claim 1, wherein a content of the metal oxide hydrate is 5 to 60 wt %.

6. A method of manufacturing a composite electrolyte membrane for a DMFC comprising:
mixing a varnish in which an organic polymer having proton conductivity is dissolved in a solvent and a varnish in which a precursor of a metal oxide hydrate having proton conductivity is dissolved in a solvent;
filming the mixture; and
effecting reaction of the precursor to disperse the metal oxide hydrate in the polymer.

7. A membrane electrode assembly comprising a cathode catalyst layer for reducing oxidizing gas and an anode catalyst layer for oxidizing methanol, the catalyst layers sandwiching an electrolyte membrane, wherein the electrolyte membrane is constituted by a metal oxide hydrate having proton conductivity and an organic polymer having proton conductivity.

8. A DMFC wherein air or oxygen is supplied to a cathode and methanol or a methanol aqueous solution is supplied to an anode thereby to generate electricity, and wherein an anode catalyst layer for reducing oxidizing gas and an anode catalyst layer for oxidizing methanol sandwich a composite electrolyte membrane constituted by a metal oxide hydrate and an organic polymer.

9. A composite electrolyte membrane for a DMFC comprising a metal oxide hydrate having proton conductivity and an organic polymer having proton conductivity.

10. The composite electrolyte membrane according to claim 9, wherein the organic polymer is aromatic hydrocarbon electrolyte.

11. The composite electrolyte membrane according to claim 9, wherein an ion exchange capacity per dry weight of the organic polymer is 0.75 to 1.67 meq/g.

12. The composite electrolyte membrane according to claim 9, wherein a content of the metal oxide hydrate is 5 to 60 wt %.

13. A membrane electrode assembly which is unified by sandwiching the composite electrolyte membrane according to claim 9 by a cathode catalyst layer for reducing oxidizing gas on one side thereof and an anode catalyst layer for oxidizing hydrogen on the other side thereof.

14. A PEFC comprising the electrolyte electrode assembly according to claim 13.
